(19) United States
(12) Patent Application Publication
(10) Pub. No.: US 2021/0021898 A1
(43) Pub. Date: Jan. 21, 2021

(54) RATING AND AN OVERALL VIEWERSHIP VALUE DETERMINED BASED ON USER ENGAGEMENT

(71) Applicant: INTERNATIONAL BUSINESS MACHINES CORPORATION, Armonk, NY (US)

(72) Inventors: Heidi Lagares-Greenblatt, Jefferson Hills, PA (US); Michael Lawrence Greenblatt, Jefferson Hills, PA (US)

(21) Appl. No.: 16/513,126

(22) Filed: Jul. 16, 2019

(51) Int. Cl. H04N 21/442; H04N 21/25; H04N 21/2668; H04N 21/81

(52) U.S. Cl. CPC H04N 21/44218; H04N 21/812; H04N 21/2668; H04N 21/252

(57) ABSTRACT

A computer-implemented method for determining media content rating and overall viewership value based on an eye gazing content. The method tracks eye gazing data of one or more users for one or more media contents. The method further analyzes the tracked eye gazing data of each of the one or more users for the one or more media contents and displays a user-inserted rating of the one or more media contents together with the analyzed eye gazing data of each of the one or more users.

### BACKGROUND

The present invention relates generally to the field of cognitive computing, computer vision technology and more particularly to data processing for accurate ratings and overall viewership value for fields such as media content (e.g., television medias, movies, video medias, advertisements, songs).

Media creators, advertisers, and users rely on ratings because it is a collection of feedbacks on viewed media content and rely on overall viewership value because it indicates popularity of each media content. These indicators may assist industry professionals to assess a program value, advertisement costs, advertisement placements, and so forth. A rating may be a user-inserted rating (e.g., a star or number rating), based on user opinion of the viewed media content.

### BRIEF SUMMARY

Embodiments of the present invention disclose a method, a computer program product, and a system.

According to an embodiment, a method, in a data processing system including a processor and a memory, for implementing a program. The method tracks eye gazing data of one or more users for one or more media contents. The method further analyzes the tracked eye gazing data of each of the one or more users for the one or more media contents and displays a user-inserted rating of the one or more media contents together with the analyzed eye gazing data of each of the one or more users.

According to another embodiment, a computer program product for directing a computer processor to implement a program. The storage device embodies program code that is executable by a processor of a computer to perform a method. The method tracks eye gazing data of one or more users for one or more media contents. The method further analyzes the tracked eye gazing data of each of the one or more users for the one or more media contents and displays a user-inserted rating of the one or more media contents together with the analyzed eye gazing data of each of the one or more users.

According to another embodiment, a system for implementing a program that manages a device, includes one or more computer devices each having one or more processors and one or more tangible storage devices. The one or more storage devices embody a program. The program has a set of program instructions for execution by the one or more processors. The method tracks eye gazing data of one or more users for one or more media contents. The method further analyzes the tracked eye gazing data of each of the one or more users for the one or more media contents and displays a user-inserted rating of the one or more media contents together with the analyzed eye gazing data of each of the one or more users.

### BRIEF DESCRIPTION OF THE DRAWINGS

FIG. 1 illustrates an eye gazing computing environment, in accordance with an embodiment of the present invention.

FIG. 2 is a flowchart illustrating the operation of an eye gazing system of FIG. 1, in accordance with an embodiment of the present invention.

FIG. 3 is a diagram graphically illustrating the hardware components of the eye gazing computing environment of FIG. 1, in accordance with an embodiment of the present invention.

FIG. 4 depicts a cloud computing environment, in accordance with an embodiment of the present invention.

FIG. 5 depicts abstraction model layers of the illustrative cloud computing environment of FIG. 4, in accordance with an embodiment of the present invention.

### DETAILED DESCRIPTION

Multimedia has become more interactive over the years. Nowadays, a user may rate a media content (e.g., a movie, a song, a video clip, etc.) after viewing and/or listening to a media content and overall viewership value is calculated based on user-inserted numbers. This rating (i.e., user-inserted rating) may influence other users' media selection process. However, not all ratings from various users are consistent with their engagement, or equal in quality.

For example, in some instances a user may have been highly engaged with a movie throughout the entire length of the movie and provided a four-star rating. In other instances, another user may have fallen asleep halfway through the movie (i.e., disengaged) but woke up at the closing credits and provided a five-star rating. One of the issues that the present invention seeks to resolve is inaccurate user-inserted ratings. The present invention may do this by tracking user engagement (i.e., eye-gaze) throughout the length of the displayed media content and determining an appropriate weight, or providing metadata, for the user-inserted rating based on the user's eye-gazing data (i.e., engagement level).

Additionally, an overall viewership value (i.e., number of viewers for certain media content) is a helpful information collected for advertisers and content creators. Currently, an overall viewership value is calculated based on viewing habits amongst randomly selected sample households. However, the calculated overall viewership value may not be an accurate depiction because the number of viewers may not be consistent with the user engagement.

For example, each household is provided with a device that monitors which media content is being displayed in a household. A member of the household self-reports how many people are watching the displayed media content. However, the current system is unable to identify wrongly reported number of viewers (e.g., a member of the household reported that 6 people were watching the displayed media content, but only 2 people were watching the displayed media content) and is unable to identify how many viewers were actually engaged with the displayed media content (e.g., whether viewers fell asleep).

The present invention resolves inaccurate overall viewership value by tracking user engagement (i.e., eye-gaze) throughout the length of the displayed media content and determining an appropriate weight, or providing metadata, for the overall viewership value based on the user's eye-gazing data (i.e., engagement level). The present invention adjusts overall viewership value by excluding viewers who were disengaged from the overall viewership value information.

A rating, for purposes of the present invention, may be a user-inserted score, or value, of a displayed media content.

An overall viewership value for the purpose of the present invention, may be a number of viewers who viewed the displayed media content. This information may be helpful to companies that measure viewing statistics of each media content by providing number of engaged viewers.

The tracked user engagement may be helpful to companies that recommend certain media content to the user based on media content viewing history of the user. For example, media contents where the user was disengaged will be excluded from consideration when determining which media content to recommend.

For the reasons discussed herein, current user-inserted rating systems have various flaws. For example, a user-inserted rating and an overall viewership value does not reflect whether the user was actually engaged with the media content or at what points in the media content the user was more engaged or less engaged. A user may not have paid attention because they were using their mobile device (e.g., texting, playing a game, engaged in social media), cooking, and/or sleeping while the media content was playing.

Moreover, when users insert a high rating for media content while they were not necessarily engaged with the media content, the current user-inserted rating systems do not have a mechanism to make the distinction between a reliable user-inserted rating (e.g., an engaged user) versus an unreliable user-inserted rating (e.g., a disengaged user).

In addition, when user reports a wrong number of viewers and not all viewers were engaged with the media content, the current overall viewership value systems, do not have a mechanism to make the distinction between a reliable overall viewership value (e.g., number of engaged users) versus an unreliable overall viewership value (e.g., user self-reported number of viewers).

Additionally, media creators and advertisers have no way of knowing, for example, which part of the media content garnered user engagement.

Throughout the present invention disclosure, reference to program ratings are not limiting but rather may further include any video, audio, and any other media content ratings. Media content, for example, may include television programming, movies, video clips, sound clips, electronic community media, or any other video content known to one of ordinary skill in art.

Hereinafter, exemplary embodiments of the present invention will be described in detail with reference to the attached drawings.

The present invention is not limited to the exemplary embodiments below but may be implemented with the various modifications within the scope of the present invention. In addition, the drawings used herein are for purposes of illustration, and may not show actual dimensions.

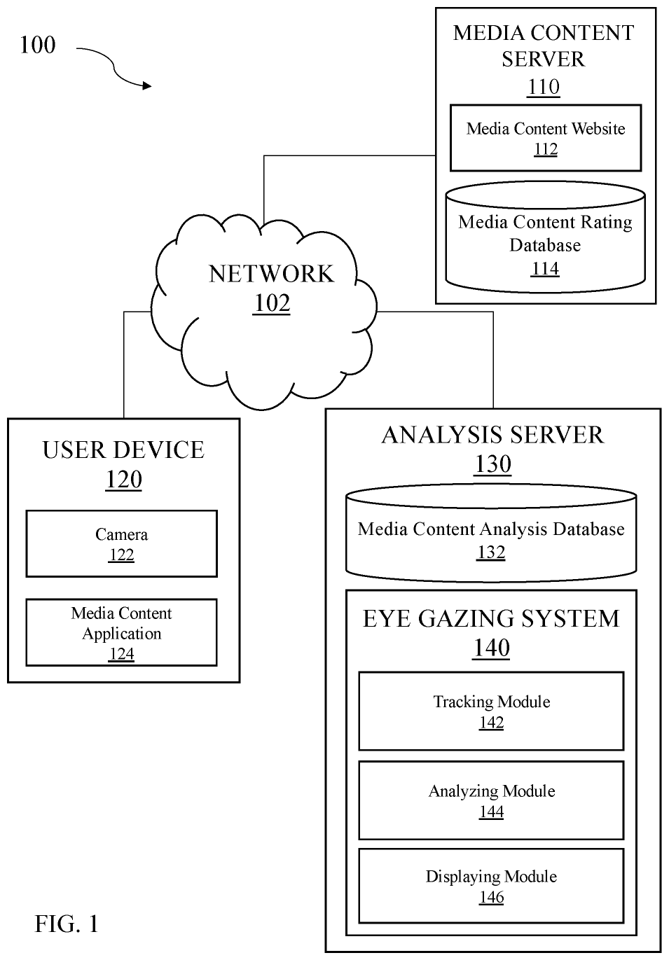

FIG. 1 illustrates eye gazing computing environment 100, in accordance with an embodiment of the present invention. Eye gazing computing environment 100 includes media content server 110, user device 120, and analysis server 130, all connected via network 102. The setup in FIG. 1 represents an example embodiment configuration for the present invention and is not limited to the depicted setup in order to derive benefit from the present invention.

With reference to FIG. 1, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, or a combination thereof. In general, network 102 can be any combination of connections and protocols that will support communications between media content server 110, user device 120, and analysis server 130.

With continued reference to FIG. 1, media content server 110 includes media content website 112 and media content rating database 114. In various embodiments, media content server 110 may be a laptop computer, tablet computer, netbook computer, personal computer (PC), a desktop computer, a personal digital assistant (PDA), a smart phone, or any programmable electronic device capable of communicating with user device 120 and analysis server 130 via network 102. While media content server 110 is shown as a single device, in other embodiments, media content server 110 may be comprised of a cluster or plurality of computing devices, working together or working separately.

In an exemplary embodiment, media content web site 112 is a website capable of hosting media content and transmitting media content to user device 120. For example, media content website 112 is capable of allowing one or more users to access media content and transmitting media content to user device 120 so the accessed media content can be displayed on user device 120.

In an exemplary embodiment, media content rating database 114 may store user name, media content identifier, user-inserted ratings, a user-reported number of viewers, devices associated with each media content rating, whether the user opted in (or out) of tracking eye gaze data, or any other category or information known to one of ordinary skill in the art. Media content rating database 114 is capable of being dynamically updated. In exemplary embodiments, users provide consent and are provided with full disclosure before any user data gets tracked, stored, and/or transmitted. Users can opt-in or opt-out of sharing user data at any time.

In exemplary embodiments, media content rating database 114 may store information, for example, as a data object with the following information: a user name (e.g., John Smith), a media content identifier (e.g., A00001), a user-inserted rating (e.g., a five-star rating), a user-reported number of viewers (e.g., six viewers), a location of the viewers of the media content (e.g., New York, N.Y.), a display device that displayed the viewed media content (e.g., television, tablet, mobile device, etc.), and whether the user opted in (or out) of providing eye gaze data (e.g., opted in). As such, the user data object, in this case, may be stored in media content rating database 114 as <Smith, John; A00001; 5; 6; NY, NY; television; opted in>.

In exemplary embodiments, media content rating database 114 receives input from user device 120 and analysis server 130.

In various embodiments, media content rating database 114 is capable of being stored on user device 120, analysis server 130, eye gazing system 140, or any other server or device connected to network 102, as a separate database.

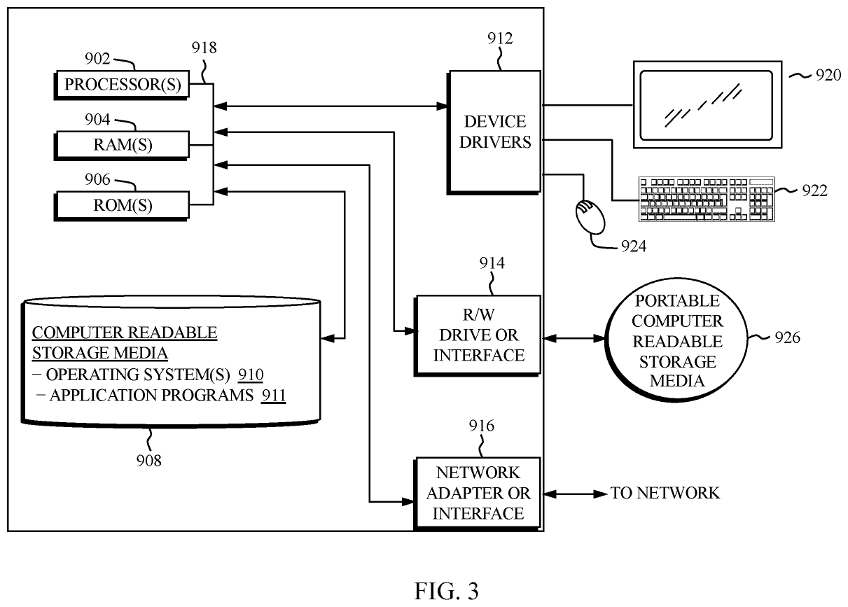

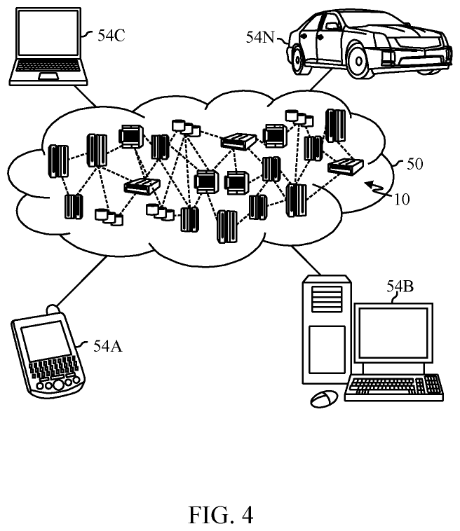

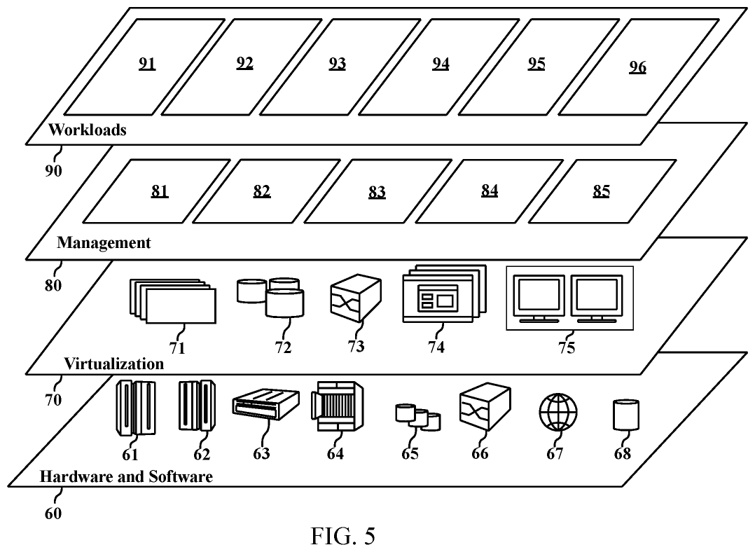

With continued reference to FIG. 1, user device 120 includes camera 122 and media content application 124 and may be a laptop computer, tablet computer, netbook computer, personal computer (PC), a desktop computer, a personal digital assistant (PDA), a smart phone, or any programmable electronic device capable of communicating with media content server 110 and analysis server 130 via network 102. User device 120 may include internal and external hardware components, as depicted and described in further detail below with reference to FIG. 3. In other embodiments, user device 120 may be implemented in a cloud computing environment, as described in relation to FIGS. 4 and 5, herein. User device 120 may also have wireless connectivity capabilities allowing user device 120 to communicate with media content server 110, analysis server 130, and other devices or servers over network 102.

In exemplary embodiments, camera 122 may include an embedded computing program or device, or a separate computing program or device, that is capable of recording one or more users while media content is being displayed on user device 120. In exemplary embodiments, camera 122 can capture real time images of one or more users, specifically with regards to tracking the eye gaze of each of the one or more users. The captured images of the one or more users may be continuously recorded and transmitted to eye gazing system 140 for analysis and/or storage on media content analysis database 132. In exemplary embodiments, users provide consent and are provided with full disclosure before any user recording data gets recorded, captured, stored, and/or transmitted. Users can opt-in or opt-out of sharing user recording data at any time.

In alternative embodiments, camera 122 may store the captured images locally on user device 120. Eye gazing system 140 may access the locally stored captured images on user device 120. In alternative embodiments, users provide consent and are provided with full disclosure before any user recording data gets stored and/or accessed. Users can opt-in or opt-out of storing user recording data at any time.

In exemplary embodiments, camera 122 may identify each of the one or more users via facial recognition, computer vision techniques, assigned password via gesture, or any other identification technique known to one of ordinary skill in the art.

In exemplary embodiments, media content application 124 may be a web browser, computer application, television set-top box, other computer programs or devices on user device 120 that are capable of accessing media content platforms (e.g., media content server 110) for the purpose of displaying, rating, and so forth. Media content application 124, in exemplary embodiments, is capable of displaying media content on user device 120 and may include access to a database of media content from a media content web server, such as media content server 110.

With continued reference to FIG. 1, analysis server 130 includes eye gazing system 140 and media content analysis database 132, and may be a laptop computer, tablet computer, netbook computer, personal computer (PC), a desktop computer, a personal digital assistant (PDA), a smart phone, or any programmable electronic device capable of communicating with media content server 110 and user device 120 via network 102. While analysis server 130 is shown as a single device, in other embodiments, analysis server 130 may be comprised of a cluster or plurality of computing devices, working together or working separately.

In exemplary embodiments, media content analysis database 132 may be a data storage on analysis server 130 that includes one or more sets of user data that corresponds to user identification numbers to identify one user from another user, past user-inserted ratings, user viewing history, and so forth. In further embodiments, media content analysis database 132 may also include captured images of users from camera 122 and/or user data corresponding to user engagement (i.e., eye gazing content data) as determined by eye gazing system 140. In exemplary embodiments, individuals may opt-in, and may opt-out at any time, to provide their viewing history and/or their user engagement.

In exemplary embodiments, media content analysis database 132 may further include metadata associated with media content, such as portions (e.g., one or more frames) of the media content that are relevant for a user to see in order to make an accurate user rating (e.g., climax scenes, character development scenes, twists in the plot of a film).

In exemplary embodiments, metadata associated with media content may be provided from the media content provider and may further include specific time spans of critical media content, past user-ratings of portions of the media content determined to be helpful to provide an accurate user rating, and other categories of metadata known to one of ordinary skill in the art.

In further embodiments, media content analysis database 132 may further include the recording data of each of the one or more users while watching the media content (e.g., total percentage of media content where the user was engaged). Media content analysis database 132 may further include comparison data between the metadata associated with the media content and the user-recorded data (e.g., eye gazing tracking data) of the media content in order to compare each of the one or more users' engagement while watching critical portions of the media content. For example, if each of the one or more users are determined to have been sleeping during a critical portion of the media content, then each of the one or more users' rating at the end of the media content may not be entirely accurate and therefore each of the one or more user's rating may be lowered in weight, or value.

In exemplary embodiments, eye gazing system 140 may access media content analysis database 132 and media content rating database 114 to retrieve user information and user tracking data.

In exemplary embodiments, eye gazing system 140 may be a computer program on analysis server 130 that includes instruction sets, executable by a processor. The instruction sets may be described using a set of functional modules. Eye gazing system 140 receives input from media content server 110, user device 120, and analysis server 130. In alternative embodiments, eye gazing system 140 may be a computer application on a separate electronic device, such as user device 120, or a separate server such as media content server 110.

With continued reference to FIG. 1, the functional modules of eye gazing system 140 include tracking module 142, analyzing module 144, and displaying module 146.

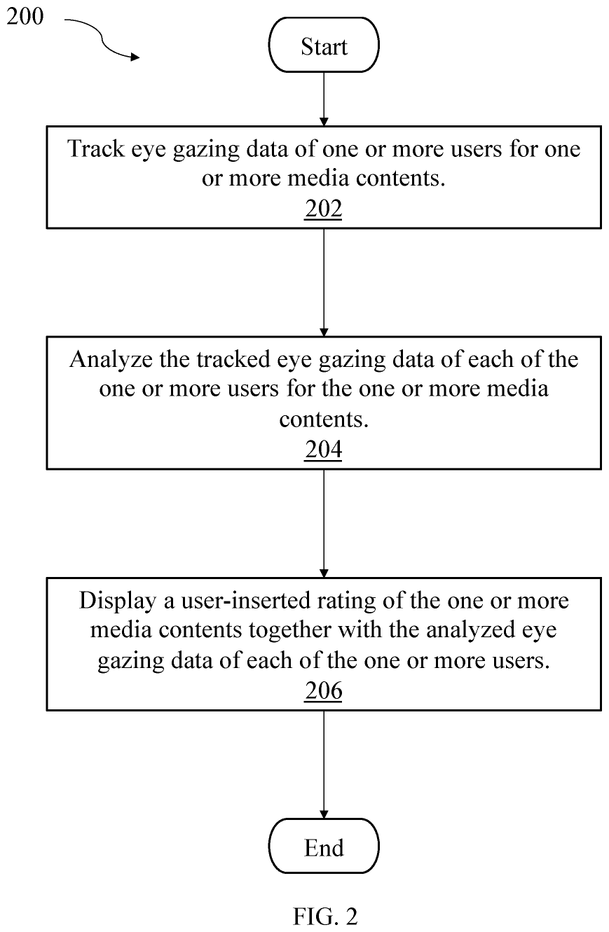

FIG. 2 illustrates eye gazing system flowchart 200 that represents the operation of eye gazing system 140 of FIG. 1, in accordance with embodiments of the present invention.

With reference to FIGS. 1 and 2, tracking module 142 includes a set of programming instructions, in eye gazing system 140, to track eye gazing content of one or more users for one or more media contents (step 202). The set of programming instructions is executable by a processor.

In exemplary embodiments, one or more media contents may include multimedia content such as television programming, movies, songs, video clips, etc.

In exemplary embodiments, tracked eye gazing data may include information on whether each of the one or more users' eyes are focused, or not focused, on the media content. For example, whether each of the one or more users' eyes are looking at the media content (e.g., user device 120), or away from the media content, during the time progression of the media content on user device 120. The recording data of each of the one or more users' eyes is transmitted from camera 122 to eye gazing system 140. In alternative embodiments, tracked eye gazing data of each of the one or more users may be analyzed in real time or from recordings stored in media content analysis database 132.

In exemplary embodiments, tracking module 142 may use existing techniques, known to one of ordinary skill in the art, for tracking one or more users' eye gazing data. For example, computer vision analysis may be utilized to track one or more users' eye gazing data from camera 122.

With reference to an illustrative example, James, Mike, and Nick are watching a television program on James' television. While the television program was playing, James got up to cook dinner, and therefore was not fully engaged with the television program. Mike and Nick continue to watch the television program, however tracking module 142 tracks Mike's eyes looking away from the television every so often. Tracking module 142 tracks Nick's eyes as highly focused on the television (e.g., user device 120). Since James, Mike, and Nick regularly watch television together at James' apartment, eye gazing system 140 identifies each of them via facial recognition techniques embedded in camera 122 on James' television and as such, associates eye gaze tracking data, of each of the users, with a respective user profile.

In alternative embodiments, tracking module 142 may be capable of tracking additional engagement data of each of the one or more users (e.g., user's facial expression, etc.). For example, a scared facial expression of a user may be used by the media content provider to determine effectiveness of scary media content for a population of users. Additionally, the facial expression metadata may be a further indicator of user engagement.

With continued reference to FIGS. 1 and 2, analyzing module 144 includes a set of programing instructions, in eye gazing system 140, to analyze eye gazing content of each of the one or more users for the one or more media contents (step 204). The set of programming instructions is executable by a processor.

In exemplary embodiments, analyzing module 144 is capable of analyzing tracked eye gazing data, from tracking module 142, to analyze user engagement for each of the one or more users. In exemplary embodiments, analyzing module 144 compares one or more time segments of the media content (e.g., metadata provided by the media content provider that details relevance value for each of the one or more time segments of the media content) with one or more instances of tracked user engagement with the media content.

In exemplary embodiments, analyzing module 144 may be capable of excluding minimal user disengagement from the tracked eye gazing data (e.g., user periodically looks at their mobile device to check the time, etc.).

On the other hand, analyzing module 144 may be capable of including the amount of time, or duration, that a user was disengaged with the displayed media content. For example, a user may respond to multiple text messages on their mobile device and was disengaged with the displayed media content longer than a threshold amount of time, or during a critical point in the displayed media content (e.g., the climax scene of the film).

In exemplary embodiments, analyzing module 144 may analyze the tracked eye gazing data for each of the one or more users, for the one or more media contents, based on at least one of the following: average duration of each of the one or more users' eye gazing engagement data with the displayed media content, a number of occurrences of each of the one or more users' disengagement with the displayed media content, a percentage of each of the one or more users' engagement with the displayed media content, a time stamp of when each of the one or more users' disengaged with the displayed media content, and a time stamp of when each of the one or more users re-engaged with the displayed media content.

In exemplary embodiments, each of the one or more users inserts a user rating of the displayed media content at the end of the media content. In alternative embodiments, the user rating may be inserted at any point of the progression of the media content.

In exemplary embodiments, analyzing module 144 is further capable of comparing the tracked eye gazing data of each of the one or more users with the media content metadata, wherein the media content metadata comprises one or more critical time segments, in order to determine if each of the one or more users were engaged with the one or more critical time segments of the displayed media content. Engagement, or disengagement, with the one or more critical time segments of the displayed media content may be helpful in determining consistency with a user-inserted rating and with an overall viewership value information.

In exemplary embodiments, analyzing module 144 is further capable of determining a weight of the user-inserted rating for each of the one or more users, based on the comparison of the tracked eye gazing data of each of the one or more users with the media content metadata, wherein the weight of the user-inserted rating increases as a percentage of user engagement during the one or more critical time segments increases.

In exemplary embodiments, analyzing module 144 is further capable of determining a weight of the overall viewership value, for each of the one or more users, based on the comparison of the tracked eye gazing data of each of the one or more users with the media content metadata, wherein the weight of the overall viewership value increases as the user engagement during the one or more critical time segments increases.

In alternative embodiments, analyzing module 144 is capable of identifying one or more segments in the one or more media contents where each of the one or more users are engaged above or equal to a threshold value. A threshold value may be a pre-configured user engagement value. In further alternative embodiments, analyzing module 144 may also be capable of identifying one or more segments in the one or more media contents where each of the one or more users are engaged below a threshold value.

With continued reference to the illustrative example above, analyzing module 144 determines that James is disengaged from the television program because he is cooking in the kitchen and missed one or more critical time segments of the television program. James inserts a user rating of 5 stars, out of 5 stars, at the end of the television program. Analyzing module 144 determines that Mike missed one or more critical time segments of the television program because he was distracted by his mobile device throughout the television program. Mike inserts a user rating of 1 star, out of 5 stars, at the end of the television program. Analyzing module 144 determines that Nick was highly engaged with the television program and watched all critical time segments of the television program. Nick inserts a user rating of 5 stars, out of 5 stars, at the end of the television program.

With continued reference to FIGS. 1 and 2, displaying module 146 includes a set of programing instructions, in eye gazing system 140, to display a user-inserted rating of the one or more media contents based on the analyzed eye gazing data of each of the one or more users (step 206). The set of programming instructions is executable by a processor.

In exemplary embodiments, displaying module 146 displays the user-inserted rating together with the determined weight assigned to the user engagement data. A determined weight assigned to the user engagement data may be obtained from a chart that matches the percentage of engagement of each of the one or more users with the one or more critical time segments of the displayed media. For example, the higher the weight, the greater the engagement of the user during the one or more critical time segments of the displayed media content. The more the user was engaged with the one or more critical time segments, the more credible the user-inserting rating may be deemed and relied upon.

In exemplary embodiments, displaying module 146 is further capable of displaying the overall viewership value together with the determined weight assigned to the user engagement data. A determined weight assigned to the user engagement data may be obtained from a chart that matches the percentage of engagement of each of the one or more users with the one or more critical time segments of the displayed media. For example, the higher the weight, the greater the engagement of the user during the one or more critical time segments of the displayed media content. The more the user was engaged with the one or more critical time segments, the more credible the overall viewership value may be deemed and relied upon.

In alternative embodiments, eye gazing system 140 may be capable of adjusting the user-inserted rating based on the determined weight of the user-inserted rating. For example, eye gazing system 140 may reduce a 5-star rating down to a 3-star rating based on determining that the user was engaged less than 60% of the time with the one or more critical time segments of the displayed media. In another example, eye gazing system 140 may keep a 5-star rating as a legitimate 5-star rating if eye gazing system 140 is determined that the user was engaged with the one or more critical time segments of the displayed media for 100% of the time.

In alternative embodiments, eye gazing system 140 may be capable of adjusting the overall viewership value based on the determined weight of the overall viewership value. For example, eye gazing system 140 may reduce user self-reported 6 viewers to 2 viewers because 4 viewers were present determined by the computer vision technology and that 2 viewers were engaged less than 60% of the time with the one or more critical time segments of the displayed media.

In further alternative embodiments, a user may search for media content (e.g., a movie) and a specific user-inserted rating for the media content based on the determined weight assigned to the specific user engagement data.

In alternative embodiments, eye gazing system 140 may be capable of determining an optimal time segment, where each of the one or more users are engaged above or equal to a threshold value, for determining optimal placement of an advertisement.

With continued reference to the illustrative example above, displaying module 146 displays James' user-inserted rating (e.g., 5 stars, out of 5 stars), on user device 120 (e.g., the television, mobile device, etc.) together with associated metadata indicating that James was only engaged with the television program for 30% of the time and therefore James' rating should not be heavily relied upon as a 5 star rating. Displaying module 146 displays Mike's user-inserted rating (e.g., 1 star, out of 5 stars) on user device 120 together with the associated metadata indicating that Mike was only engaged with the television program 50% of the time, since he was distracted with his mobile device and missed critical time segments of the television program. Displaying module 146 displays Nick's user inserted rating (e.g., 5 stars, out of 5 stars) together with the associated metadata indicating that Nick was highly engaged with every critical time segment of the television program and therefore his 5-star rating is reliable.

FIG. 3 is a block diagram depicting components of a computing device (such as media content server 110, user device 120 or analysis server 130, as shown in FIG. 1), in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Computing device of FIG. 3 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as eye gazing system 140, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device of FIG. 3 may also include a R/W drive or interface 914 to read from and write to one or more portable computer readable storage media 926. Application programs 911 on the computing device may be stored on one or more of the portable computer readable storage media 926, read via the respective R/W drive or interface 914 and loaded into the respective computer readable storage media 908.

Computing device of FIG. 3 may also include a network adapter or interface 916, such as a TCP/IP adapter card or wireless communication adapter (such as a 4G wireless communication adapter using OFDMA technology). Application programs 911 on the computing device may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device of FIG. 3 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this invention disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling access to data objects 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A computer-implemented method comprising:
tracking eye gazing data of one or more users for one or more media contents, via a continuously monitoring camera;
associating the tracked eye gazing data of the one or more users with one or more unique user accounts;
analyzing the tracked eye gazing data of each of the one or more users for the one or more media contents;
comparing the analyzed tracked eye gazing data of each of the one or more users with media content metadata, wherein the media content metadata comprises one or more critical time segments;
determining which of the one or more media contents leads to greater user attention, for the one or more users, based on the comparison; and
displaying a user-inserted rating of the one or more media contents together with the analyzed eye gazing data of each of the one or more users.

2. (canceled)

3. The computer-implemented method of claim 1, further comprising:
determining a weight of the user-inserted rating for each of the one or more users, based on the comparison, wherein the weight of the user-inserted rating increases as a percentage of user engagement increases during the one or more critical time segments; and
adjusting the user-inserted rating based on the determined weight of the user-inserted rating.

4. The computer-implemented method of claim 1, further comprising:
displaying an overall viewership value of the one or more media contents together with the analyzed eye gazing data of each of the one or more users.

5. The computer-implemented method of claim 3, further comprising:
determining a weight of an overall viewership value for each of the one or more users, based on the comparison, wherein the weight of the overall viewership value increases as the user engagement increases during the one or more critical time segments; and
adjusting the overall viewership value based on the determined weight of the overall viewership value.

6. The computer-implemented method of claim 4, further comprising:
identifying one or more segments in the one or more media contents where each of the one or more users are engaged above, or equal to, a threshold value; and
identifying one or more segments in the one or more media contents where each of the one or more users are engaged below the threshold value.

7. The computer-implemented method of claim 1, wherein the analyzed eye gazing data of each of the one or more users for the one or more media contents are analyzed based on at least one of the following in a group consisting of: average duration of each of the one or more users' eye gazing engagement data with the displayed media content, a number of occurrences of each of the one or more users' disengagement with the displayed media content, a percentage of each of the one or more users' engagement with the displayed media content, a time stamp of when each of the one or more users' disengaged with the displayed media content, and a time stamp of when each of the one or more users re-engaged with the displayed media content.

8. The computer-implemented method of claim 6, further comprising:
determining an optimal placement for an advertisement within the identified one or more segments in the one or more media contents where each of the one or more users are engaged above, or equal to, the threshold value.

9. A computer program product for implementing a program that manages a device, the computer program product comprising a computer readable storage medium having program instructions embodied therewith, the program instruction executable by a processor of a computer to perform a method, the method comprising:
tracking eye gazing data of one or more users for one or more media contents, via a continuously monitoring camera;
associating the tracked eye gazing data of the one or more users with one or more unique user accounts;
analyzing the tracked eye gazing data of each of the one or more users for the one or more media contents;
comparing the analyzed tracked eye gazing data of each of the one or more users with media content metadata, wherein the media content metadata comprises one or more critical time segments;
determining which of the one or more media contents leads to greater user attention, for the one or more users, based on the comparison; and
displaying a user-inserted rating of the one or more media contents together with the analyzed eye gazing data of each of the one or more users.

10. (canceled)

11. The computer program product of claim 9, further comprising:
displaying an overall viewership value of the one or more media contents together with the analyzed eye gazing data of each of the one or more users;
identifying one or more segments in the one or more media contents where each of the one or more users are engaged above, or equal to, a threshold value; and
identifying one or more segments in the one or more media contents where each of the one or more users are engaged below the threshold value.

12. The computer program product of claim 9, further comprising:
determining a weight of the user-inserted rating for each of the one or more users, based on the comparison, wherein the weight of the user-inserted rating increases as a percentage of user engagement increases during the one or more critical time segments; and
adjusting the user-inserted rating based on the determined weight of the user-inserted rating;
determining a weight of an overall viewership value for each of the one or more users, based on the comparison, wherein the weight of the overall viewership value increases as the user engagement increases during the one or more critical time segments; and
adjusting the overall viewership value based on the determined weight of the overall viewership value.

13. The computer program product of claim 9, wherein the analyzed eye gazing data of each of the one or more users for the one or more media contents are analyzed based on at least one of the following in a group consisting of: average duration of each of the one or more users' eye gazing engagement data with the displayed media content, a number of occurrences of each of the one or more users' disengagement with the displayed media content, a percentage of each of the one or more users' engagement with the displayed media content, a time stamp of when each of the one or more users' disengaged with the displayed media content, and a time stamp of when each of the one or more users re-engaged with the displayed media content.

14. The computer program product of claim 11, further comprising:
determining an optimal placement for an advertisement within the identified one or more segments in the one or more media contents where each of the one or more users are engaged above, or equal to, the threshold value.

15. A computer system for implementing a program that manages a device, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
tracking eye gazing data of one or more users for one or more media contents, via a continuously monitoring camera;
associating the tracked eye gazing data of the one or more users with one or more unique user accounts;
analyzing the tracked eye gazing data of each of the one or more users for the one or more media contents;
comparing the analyzed tracked eye gazing data of each of the one or more users with media content metadata, wherein the media content metadata comprises one or more critical time segments;
determining which of the one or more media contents leads to greater user attention, for the one or more users, based on the comparison; and
displaying a user-inserted rating of the one or more media contents together with the analyzed eye gazing data of each of the one or more users.

16. (canceled)

17. The computer system of claim 15, further comprising:
displaying an overall viewership value of the one or more media contents together with the analyzed eye gazing data of each of the one or more users;
identifying one or more segments in the one or more media contents where each of the one or more users are engaged above, or equal to, a threshold value; and
identifying one or more segments in the one or more media contents where each of the one or more users are engaged below the threshold value.

18. The computer system of claim 15, further comprising:
determining a weight of the user-inserted rating for each of the one or more users, based on the comparison, wherein the weight of the user-inserted rating increases as a percentage of user engagement increases during the one or more critical time segments;
adjusting the user-inserted rating based on the determined weight of the user-inserted rating;
determining a weight of an overall viewership value for each of the one or more users, based on the comparison, wherein the weight of the overall viewership value increases as the percentage of user engagement increases during the one or more critical time segments; and
adjusting the overall viewership value based on the determined weight of the overall viewership value.

19. The computer system of claim 15, wherein the analyzed eye gazing data of each of the one or more users for the one or more media contents are analyzed based on at least one of the following in a group consisting of: average duration of each of the one or more users' eye gazing engagement data with the displayed media content, a number of occurrences of each of the one or more users' disengagement with the displayed media content, a percentage of each of the one or more users' engagement with the displayed media content, a time stamp of when each of the one or more users' disengaged with the displayed media content, and a time stamp of when each of the one or more users re-engaged with the displayed media content.

20. The computer system of claim 17, further comprising:
determining an optimal placement for an advertisement within the identified one or more segments in the one or more media contents where each of the one or more users are engaged above, or equal to, the threshold value.
